(19) United States
(12) Patent Application Publication
(10) Pub. No.: US 2005/0001855 A1
(43) Pub. Date: Jan. 6, 2005

(54) Method of and apparatus for enlarging image and printing enlarged image and computer-readable recording medium for storing computer program

(76) Inventor: Eun-sook Kang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/790,091

(22) Filed: Mar. 2, 2004

(30) Foreign Application Priority Data
Jul. 2, 2003 (KR) 2003-44537

(51) Int. Cl. G09G 5/00

(52) U.S. Cl. 345/660

(57) ABSTRACT

Provided are a method of and an apparatus for enlarging an image and printing an enlarged image and a computer-readable medium of instructions for controlling a system to perform the method. The method includes identifying an image file having an image to be enlarged and printed, determining the number of pixels of the image using the identified image file, determining an enlargement ratio corresponding to the determined number of pixels, and enlarging the image at the determined enlargement ratio and printing the enlarged image.

### CROSS REFERENCE TO RELATED APPLICATION

This application claims priority under 35 U.S.C. §119(a) from Korean Patent Application No. 2003-44537, filed on Jul. 2, 2003, in the Korean Intellectual Property Office, the disclosure of which is hereby incorporated by reference in its entirety.

### BACKGROUND OF THE INVENTION

1. Field of the Invention

The present invention relates to enlarged image printing. More particularly, the present invention relates to a method of and an apparatus for enlarging an image and printing an enlarged image while maintaining image quality and a computer-readable recording medium for storing a computer program to perform the method.

2. Description of the Related Art

Hereinafter, a conventional method of enlarging an image and printing an enlarged image will be explained with reference to FIGS. 1A, 1B, 2A, and 2B.

FIG. 1A illustrates a real-size image with a low resolution and FIG. 1B illustrates the image of FIG. 1A after it has been enlarged and printed.

The conventional method of enlarging an image and printing an enlarged image can enlarge an image with a low resolution, as shown in FIG. 1A. The image containing approximately 7 hundred thousand pixels can be enlarged into a fill paper size, as shown in FIG. 1A, and the enlarged image can then be printed.

FIG. 2A illustrates a real-size image with a high resolution and FIG. 2B illustrates the image of FIG. 2A after it has been enlarged and printed.

The conventional method of enlarging an image and printing an enlarged image can enlarge an image with a high resolution, as shown in FIG. 2A. The image containing approximately 5 million pixels can be enlarged into a full paper size, as shown in FIG. 2B, and the enlarged image can then be printed.

As such, according to the conventional method of enlarging an image and printing an enlarged image, an image is enlarged at a given enlargement ratio regardless of the resolution of the image to be enlarged and printed. In other words, the image is printed after being enlarged at an enlargement ratio that is determined to enlarge the image to a full paper size. In this case, when the image with a high resolution, as shown in FIG. 2A, is enlarged into a full paper size and is then printed, the enlarged image still maintains the high resolution as shown in FIG. 2B. However, when the image with a low resolution, as shown in FIG. 1A, is enlarged into a full paper size and is then printed, lattice patterns are generated near the middle of the enlarged image as shown in FIG. 1B, resulting in degradation of image quality. If users desire to print a new enlarged image in order to remove such degradation, according to the conventional method of enlarging an image and printing an enlarged image, users have to set a new enlargement ratio and then print the enlarged image. As a result, paper, ink, and printing time are unduly consumed. Accordingly, the conventional method of enlarging an image and printing an enlarged image brings inconvenience to users.

### SUMMARY OF THE INVENTION

The present invention provides a method of printing an enlarged image, by which an image can be enlarged to the maximum and then printed without degradation of image quality.

The present invention also provides an apparatus for enlarging an image and printing an enlarged image, which can enlarge an image to the maximum and print the enlarged image without degrading image quality.

The present invention also provides a computer-readable recording medium for storing a computer program that controls enlarging an image and printing an enlarged image.

According to one aspect of the present invention, there is provided a method of enlarging an image and printing an enlarged image. The method comprises determining an image file having an image to be enlarged and printed, determining the number of pixels of the image using the determined image file, determining an enlargement ratio corresponding to the determined number of pixels, and enlarging the image at the determined enlargement ratio and printing the enlarged image.

According to another aspect of the present invention, there is provided an apparatus for enlarging an image and printing an enlarged image. The apparatus comprises a file determining portion, a number-of-pixels determining portion, an enlargement ratio determining portion, and a printing portion. The file determining portion determines an image file having an image to be enlarged and printed and outputs the determined image file. The number-of-pixels determining portion determines the number of pixels of the image using the determined image file received from the file determining portion. The enlargement ratio determining portion determines an enlargement ratio corresponding to the determined number of pixels received from the number-of-pixels determining portion. The printing portion enlarges the image at the determined enlargement ratio received from the enlargement ratio determining portion and prints the enlarged image.

According to yet another aspect of the present invention, there is provided a computer-readable recording medium for storing a computer program controlling for enlarging an image and printing an enlarged image, according to a process comprising determining an image file having an image to be enlarged and printed, determining the number of pixels of the image using the determined image file, determining an enlargement ratio corresponding to the determined number of pixels, and enlarging the image at the determined enlargement ratio and printing the enlarged image.

### BRIEF DESCRIPTION OF THE DRAWINGS

The above and other aspects and advantages of the present invention will become more apparent by describing in detail exemplary embodiments thereof with reference to the attached drawing figures in which:

FIGS. 1A and 1B illustrate a real-size image with a low resolution and the image of FIG. 1A after it has been enlarged and printed;

FIGS. 2A and 2B illustrate a real-size image with a high resolution and the image of FIG. 2A after it has been enlarged and printed;

FIG. 3 is a flowchart for explaining a method of enlarging an image and printing an enlarged image according to embodiments of the present invention;

FIG. 4 is a block diagram of an apparatus for enlarging an image and printing an enlarged image according to embodiments of the present invention;

FIGS. 5A and 5B illustrate a real-size image with a low resolution and the image of FIG. 5A after it has been enlarged and printed; and

FIGS. 6A and 6B illustrate a real-size image with a high resolution and the image of FIG. 6A after it has been enlarged and printed.

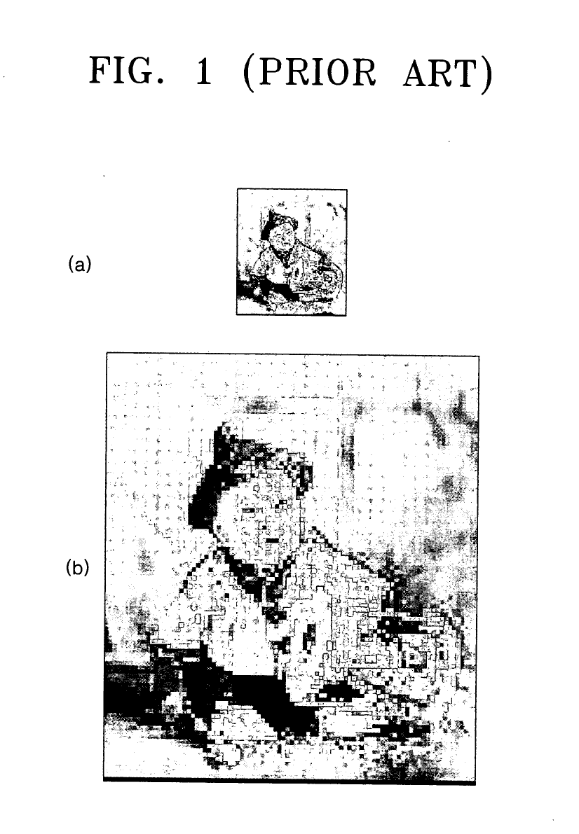

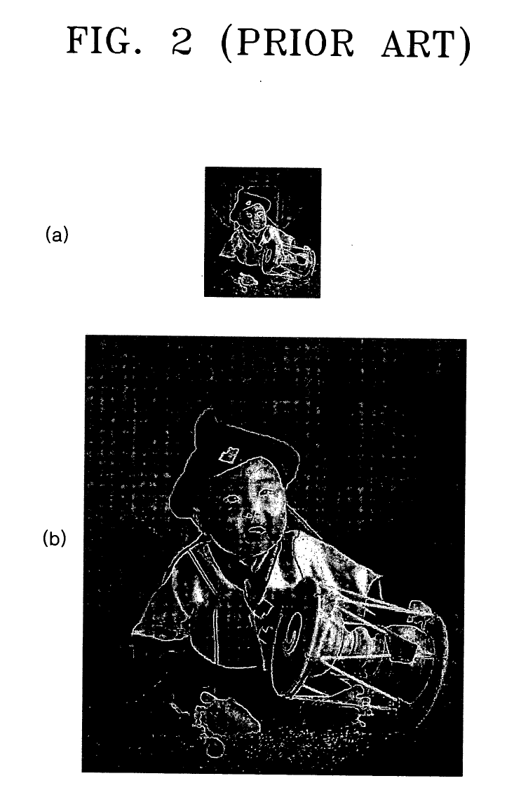

### DETAILED DESCRIPTION OF THE EMBODIMENTS

The present invention will now be described more fully with reference to the accompanying drawing figures, in which preferred embodiments of the invention are shown. In the drawing figures, like reference numerals are used to refer to like elements throughout.

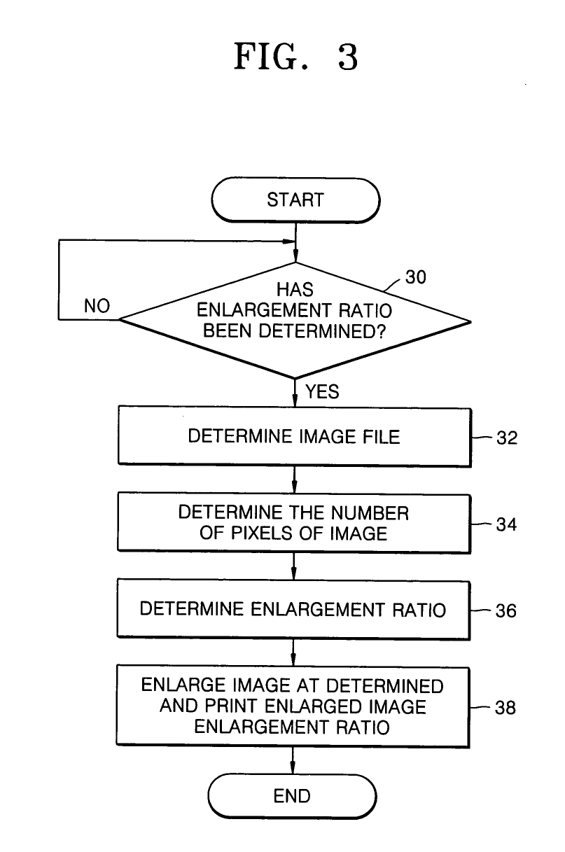

FIG. 3 is a flowchart for explaining a method of enlarging an image and printing an enlarged image according to embodiments of the present invention. The method of enlarging an image and printing an enlarged image comprises steps 30 through 38 where an image is enlarged at an enlargement ratio determined using an image file and is then printed.

The method of enlarging an image and printing an enlarged image, shown in FIG. 3, is performed when printing of an enlarged image is requested.

According to an embodiment of the present invention, as shown in FIG. 3, the method of enlarging an image and printing an enlarged image begins with checking if an enlargement ratio at which an image is to be enlarged has been determined in step 30. If the enlargement ratio has not been determined, a process proceeds to step 30. However, if the enlargement ratio has been determined, an image file having an image to be enlarged and printed is determined in step 32. Here, the enlargement ratio may be determined by a user or be determined in advance. For example, if a user who desires to enlarge an image into a full paper size and to print the enlarged image previously determines an enlargement ratio, the process may proceed to step 32.

According to another embodiment of the present invention, unlike FIG. 3, a method of enlarging an image and printing an enlarged image according to an embodiment of the present invention may not comprise step 30. In this case, first, an image file having an image to be enlarged and printed is determined in step 32, regardless of whether the enlargement ratio at which the image is to be enlarged has been determined or not.

According to embodiments of the present invention, in step 32, the image file having the image to be enlarged and printed may be selected from among numerous image files or may be provided from an outside source.

After completion of step 32, the number of pixels of the image is obtained using the selected or provided image file in step 34. For example, the number of pixels of the image can be extracted from header information stored in the selected or provided image file.

After completion of step 34, an enlargement ratio corresponding to the obtained number of pixels is determined in step 36. Here, the enlargement ratio at which the image can be enlarged and printed according to the obtained number of pixels of the image while maintaining the optimal image quality may be determined experimentally. For example, the enlargement ratio may be determined according to the number of pixels of the image, as shown in Table 1.

TABLE 1

| The number of pixels | Enlargement ratio |
|---|---|
| Not determined | 100% |
| Less than 3 hundred thousand | 110% |
| Less than 5 hundred thousand | 120% |
| Less than 7 hundred thousand | 159% |
| Less than 1 million | 200% |
| . . . | . . . |
| Less than 4 million | 600% |
| Less than 5 million | 800% |

After completion of step 36, the image is enlarged at the determined enlargement ratio and then printed in step 38.

Hereinafter, the structure and operation of an apparatus for enlarging an image and printing an enlarged image will be described with reference to attached drawing figures.

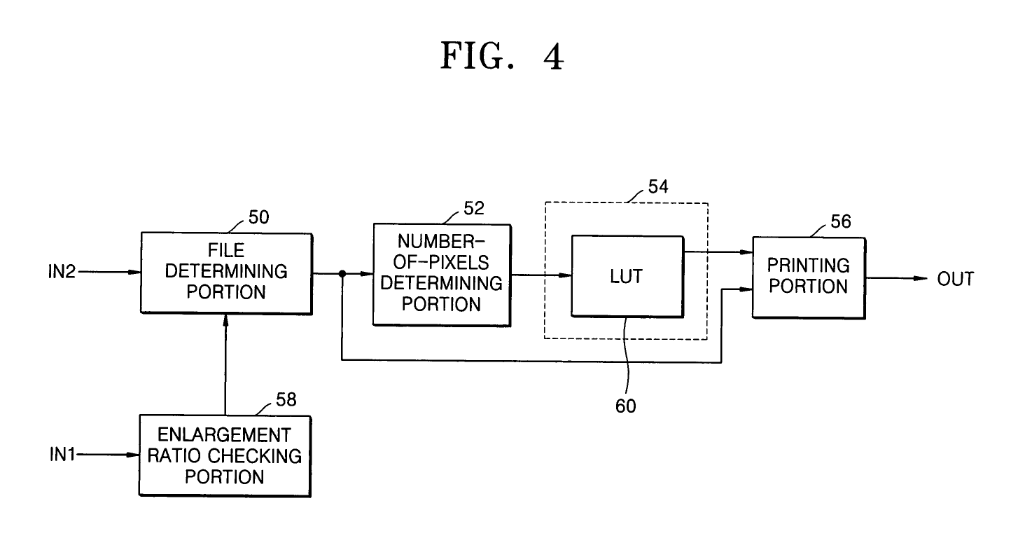

FIG. 4 is a block diagram of an apparatus for enlarging an image and printing an enlarged image according to embodiments of the present invention. The apparatus for enlarging an image and printing an enlarged image includes a file determining portion 50, a number-of-pixels determining portion 52, an enlargement ratio determining portion 54, a printing portion 56, and an enlargement ratio checking portion 58.

The apparatus for enlarging an image and printing an enlarged image, shown in FIG. 4, can perform the method of enlarging an image and printing an enlarged image, shown in FIG. 3.

When the method of printing an enlarged image, shown in FIG. 3, does not comprise step 30, the file determining portion 50 determines an image file having an image to be enlarged and printed, and outputs the determined image file to the number-of-pixels determining portion 52 and the printing portion 56 so as to perform step 32.

However, when the method of enlarging an image and printing an enlarged image, shown in FIG. 3, comprises step 30, the apparatus for enlarging an image and printing an enlarged image, shown in FIG. 4, may further include the enlargement ratio checking portion 58. Here, the enlargement ratio checking portion 58 checks if the enlargement ratio at which the image is to be enlarged has been determined and outputs the check result as a control signal to the file determining portion 50 for the purpose of performing step 30. For example, the enlargement ratio checking portion 58 receives the enlargement ratio from a key manipulating portion (not shown) through an input terminal IN1. The key manipulating portion generates an enlargement ratio after being manipulated by a user who desires to determine the enlargement ratio. The enlargement ratio checking portion 58 outputs the control signal generated according to the received enlargement ratio to the file determining portion 50. At this time, the file determining portion 50 identifies the image file having the image to be enlarged and printed, in response to the control signal output from the enlargement ratio checking portion 58. In other words, if it is recognized through the control signal that the enlargement ratio has been determined, the file determining portion 50 identifies the image file having the image to be enlarged.

According to an embodiment of the present invention, the file determining portion 50 receives numerous image files through an input terminal IN2, selects the image file having the image to be enlarged and printed from among the numerous image files, and outputs the selected image file to the number-of-pixels determining portion 52 and the printing portion 56.

According to another embodiment of the present invention, the file determining portion 50 outputs an image file input from the outside through the input terminal IN2 to the number-of-pixels determining portion 52 and the printing portion 56.

At this time, the file determining portion 50 may receive the image file(s) from a digital still camera (not shown), a mobile phone having an image photographing function (not shown), or a camcorder (not shown) for example.

To perform step 34, the number-of-pixels determining portion 52 determines the number of pixels of the image using the determined image file output from the file determining portion 50 and outputs the determined number of pixels of the image to the enlargement ratio determining portion 54. To this end, the number-of-pixels determining portion 52 may extract the number of pixels of the image from header information that is stored in the determined image file output from the file determining portion 50 and may output the extracted number of pixels of the image to the enlargement ratio determining portion 54.

To perform step 36, the enlargement ratio determining portion 54 determines an enlargement ratio corresponding to the determined number of pixels of the image, output from the number-of-pixels determining portion 52, and outputs the determined enlargement ratio to the printing portion 56. To this end, the enlargement ratio determining portion 54 may be implemented as a look up table (LUT) 60 as shown in FIG. 4. Here, the LUT 60 receives the determined number of pixels of the image, output from the number-of-pixels determining portion 52, as an address, reads out the enlargement ratio stored as data in the received address, and outputs the read enlargement ratio to the printing portion 56.

To perform step 38, the printing portion 56 receives the determined image file from the file determining portion 50, enlarges the image included in the received image file at the determined enlargement ratio received from the enlargement ratio determining portion 54, prints the enlarged image, and outputs the printed result through an output terminal OUT.

The apparatus for enlarging an image and printing an enlarge image according to an embodiment of the present invention, shown in FIG. 4, may be embedded in a printer (not shown).

Hereinafter, a computer-readable recording medium for storing a computer program that controls enlarging an image and printing an enlarged image will be explained.

The computer program stored in the computer-readable recording medium can perform a step of identifying an image file having an image to be enlarged and printed, a step of obtaining the number of pixels of the image using the determined image file, a step of determining an enlargement ratio corresponding to the obtained number of pixels of the image, and a step of enlarging the image at the determined enlargement ratio and printing the enlarged image. At this time, a computer program performing the step of obtaining the number of pixels of the image can extract the number of pixels of the image using header information stored in the determined image file.

Also, the computer program can further perform a step of checking if the enlargement ratio has been determined and determining the image file if the enlargement ratio has been determined.

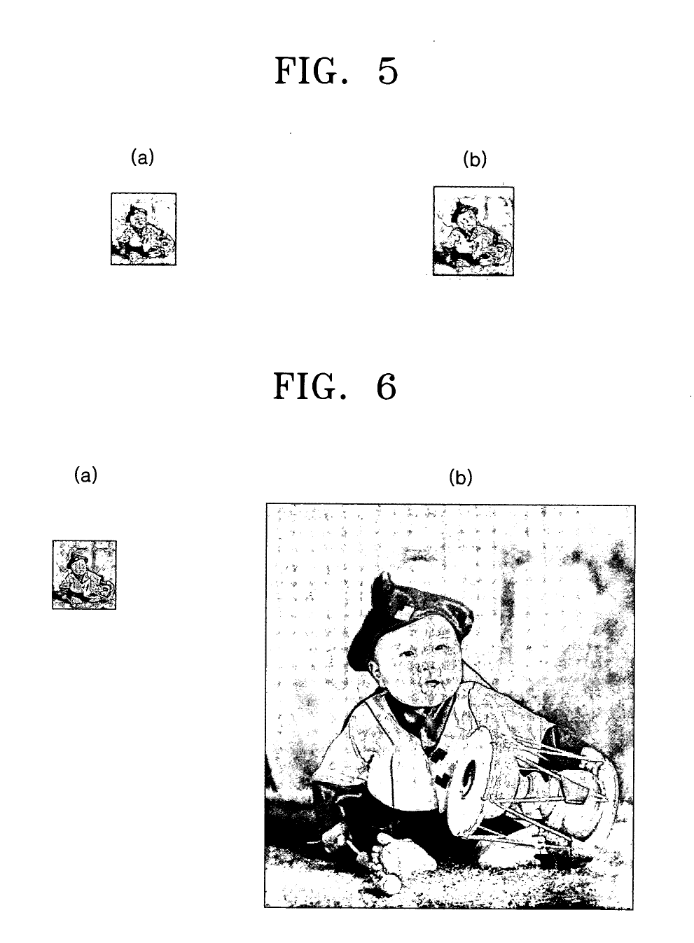

FIG. 5A illustrates a real-size image with a low resolution and FIG. 5B illustrates the image of FIG. 5A after it has been enlarged and printed.

The method of and the apparatus for enlarging an image and printing an enlarged image and the computer program stored in the computer-readable recording medium according to an embodiment of the present invention may enlarge an image with a low resolution such as an image containing 7 hundred thousand pixels, as shown in FIG. 5A, at a determined enlargement ratio, such as 159% as shown in Table 1 and may print the enlarged image as shown in FIG. 5B, instead of enlarging the image with a low resolution to a full paper size and printing the enlarged image. As such, even when the image containing a small number of pixels, as shown in FIG. 5A, is enlarged at a relatively small enlargement ratio and is then printed, the enlarged and printed image maintains its optimal quality as shown in FIG. 5B.

FIG. 6A illustrates a real-size image with a high resolution and FIG. 6B illustrates the image of FIG. 6A after it has been enlarged and printed.

The method of and the apparatus for enlarging an image and printing an enlarged image and the computer program stored in the recording medium according to an embodiment of the present invention may enlarge an image with a high resolution, such as an image containing 5 million pixels as shown in FIG. 6A, up to a full paper size, such as 800%, as shown in Table 1 and may print the enlarged image as shown in FIG. 6B. As such, even when the image with a large number of pixels, shown in FIG. 6A, is enlarged at a relatively large enlargement ratio and is then printed, the enlarged and printed image maintains its optimal quality as shown in FIG. 6B.

Accordingly, the method of and the apparatus for enlarging an image and printing an enlarged image and the computer-readable recording medium for storing a computer program enlarge an image to be enlarged and printed at an enlargement ratio determined according to a resolution of the image (the number of pixels of the image), and print the enlarged image. Here, the enlargement ratio at which an image with a low resolution (an image containing a small number of pixels), is enlarged is smaller than the enlargement ratio at which an image with a high resolution (an image containing a large number of pixels), is enlarged.

As described above, the method of and the apparatus for printing an enlarged image and the computer-readable recording medium for storing a computer program according to an embodiment of the present invention enlarge an image to be enlarged and printed at an enlargement ratio that is automatically determined according to the number of pixels of the image and then print the enlarged image. Thus, the image can be enlarged to the maximum and then printed without degradation of image quality. Consequently, it is possible to prevent ink, paper, and printing time from being unduly consumed when the enlarged image is again printed to remove degradation, thereby providing convenience to users.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

1. A method of enlarging an image and printing an enlarged image, the method comprising:
identifying an image file having an image to be enlarged and printed;
determining the number of pixels of the image using the determined image file;
determining an enlargement ratio corresponding to the determined number of pixels; and
enlarging the image at the determined enlargement ratio and printing the enlarged image.

2. The method of claim 1, wherein the image file identifying step further comprises selecting the image file to be enlarged and printed from among numerous image files.

3. The method of claim 1, wherein the image file is provided from an outside source.

4. The method of claim 1, wherein the number of pixels of the image is extracted from header information stored in the determined image file.

5. The method of claim 1 further comprising checking if the enlargement ratio has been determined and proceeding to the image file identifying step if the enlargement ratio has been determined.

6. An apparatus for enlarging an image and printing an enlarged image, the apparatus comprising:
a file identifying portion, which identifies an image file having an image to be enlarged and printed and outputs the identified image file;
a number-of-pixels determining portion, which determines the number of pixels of the image using the identified image file received from the file identifying portion;
an enlargement ratio determining portion, which determines an enlargement ratio corresponding to the determined number of pixels received from the number-of-pixels determining portion; and
a printing portion, which enlarges the image at the determined enlargement ratio received from the enlargement ratio determining portion and prints the enlarged image.

7. The apparatus of claim 6, wherein the file identifying portion selects the image file having the image to be enlarged and printed from among numerous image files and outputs the selected image file as the identified image file to the number-of-pixels determining portion.

8. The apparatus of claim 6, wherein the file identifying portion is provided with the image file from an outside source having the image to be enlarged and printed and outputs the provided image file as the identified image file to the number-of-pixels determining portion.

9. The apparatus of claim 6, wherein the number-of-pixels determining portion extracts the number of pixels of the image from header information stored in the identified image file.

10. The apparatus of claim 6, further comprising an enlargement ratio checking portion which checks if the enlargement ratio has been determined and outputs as a control signal the check result, wherein, in response to the control signal, the file identifying portion identifies the image file having the image to be enlarged and printed.

11. The apparatus of claim 6, wherein the enlargement ratio determining portion includes a look up table that receives as an address the determined number of pixels of the image from the number-of-pixels determining portion and reads out the enlargement ratio stored as data in the received address.

12. A computer-readable medium of instructions adapted to control a system for enlarging an image and printing an enlarged image, comprising:
a first set of instructions adapted to control the system to identify an image file having an image to be enlarged and printed;
a second set of instructions adapted to control the system to determine the number of pixels of the image using the identified image file;
a third set of instructions adapted to control the system to determine an enlargement ratio corresponding to the determined number of pixels; and
a fourth set of instructions adapted to control the system to enlarge the image at the determined enlargement ratio and print the enlarged image.

13. The computer-readable medium of instructions of claim 12, wherein the second set of instructions is adapted to extract the number of pixels of the image from header information stored in the identified image file.

14. The computer-readable medium of instructions of claim 12, further comprising a fifth set of instructions adapted to control the system to check if the enlargement ratio has been determined and to proceed to the first set of instructions if the enlargement ratio has been determined.
